(19) United States
(12) Patent Application Publication
(10) Pub. No.: US 2022/0402421 A1
(43) Pub. Date: Dec. 22, 2022

(54) VEHICLE TRANSPORTING DEVICE

(71) Applicant: TOYOTA JIDOSHA KABUSHIKI KAISHA, Toyota-shi Aichi-ken (JP)

(72) Inventors: Toshiki Kitajima, Mishima-shi Shizuoka-ken (JP); Norinao Watanabe, Susono-shi Shizuoka-ken (JP); Yutaka Nakamura, Susono-shi Shizuoka-ken (JP); Kohei Yasuda, Susono-shi Shizuoka-ken (JP)

(73) Assignee: TOYOTA JIDOSHA KABUSHIKI KAISHA, Toyota-shi Aichi-ken (JP)

(21) Appl. No.: 17/719,966

(22) Filed: Apr. 13, 2022

(30) Foreign Application Priority Data
Jun. 21, 2021 (JP) 2021-102603

(51) Int. Cl. B60P 3/077

(52) U.S. Cl. CPC B60P 3/077; B66F 5/04

(57) ABSTRACT

A vehicle transporting device includes a bogie frame, a total of eight arms, upper surface plates, and arm driving units. Two arms in a longitudinal direction of the bogie frame of the total of eight arms are paired with each other to support tires. The upper surface plates extend in a width direction of the bogie frame to support the arms. At least six arm driving units are provided on the bogie frame to individually drive at least six arms. Base end portions of pivoting arms are pivotably supported by the upper surface plates in outer peripheral regions of the upper surface plates. Tip portions of the pivoting arms are located outside the upper surface plates. One ends of the arm driving units are attached partway through the pivoting arms. The other ends of the arm driving units are located outside the bogie frame.

### CROSS-REFERENCE TO RELATED APPLICATION

This application claims priority to Japanese Patent Application No. 2021-102603 filed on Jun. 21, 2021, incorporated herein by reference in its entirety.

### BACKGROUND

### 1. Technical Field

The present disclosure relates to a device for transporting a four-wheeled vehicle.

### 2. Description of Related Art

Japanese Unexamined Patent Application Publication No. 2019-078099 (JP 2019-078099 A) discloses a device for transporting a four-wheeled vehicle. This conventional device includes a bogie frame, a total of eight arm portions, and arm support portions. Two front and rear arms of the total of eight arms are paired with each other to support each tire of a four-wheeled vehicle. Each arm portion pivots from a release state in which the arm portion is parallel to the longitudinal direction of the bogie frame to a clamp state in which the arm portion is parallel to the direction (lateral direction) orthogonal to the longitudinal direction.

The arm support portions extend in the lateral direction of the bogie frame. In this lateral direction, both ends of the arm support portions are located on the outside of the bogie frame. The base end portion of each arm portion is attached to this outer position. The pivot of the pair of the front and rear arm portions is performed by the operation of the arm driving unit provided for each pair of arm portions. This arm driving unit has a link mechanism. Therefore, when the arm driving unit is operated, the pair of front and rear arm portions operates in conjunction with each other.

### SUMMARY

Since the conventional device is provided with an arm driving unit for each pair of front and rear arm portions, there is an advantage that the total number of arm driving units can be reduced. However, since the link mechanism is housed below the arm support portions, the size of the link mechanism in the vertical direction (that is, height) becomes an issue. In order to transport various four-wheeled vehicles, it is necessary to slide the bogie part including the bogie frame and the arm support portions into the space below the vehicle body. However, there is a limit to the reduction in the height of the link mechanism. Therefore, further improvement is required from the viewpoint of reducing the height of the bogie part.

An object of the present disclosure is to provide a technique capable of reducing the size of a bogie part in the vertical direction of a device for transporting a four-wheeled vehicle.

The present disclosure provides a vehicle transporting device for transporting a four-wheeled vehicle, and has the following features. The vehicle transporting device includes a bogie frame, a total of eight arms, upper surface plates, and arm driving units. The bogie frame is inserted into a space below a vehicle body from front or rear of the four-wheeled vehicle. The arms are each provided in a direction orthogonal to a longitudinal direction of the bogie frame. Two arms in the longitudinal direction of the arms are paired with each other to support each tire of the four-wheeled vehicle. The upper surface plates extends in the orthogonal direction on an upper surface of the bogie frame. The upper surface plates support the arms. At least six arm driving units are provided on the bogie frame. The at least six arm driving units individually switch each state of at least six pivoting arms included in the arms between a tire support state and a tire release state.

Each base end portion of the at least six pivoting arms is pivotably supported by each of the upper surface plates in an outer peripheral region of each of the upper surface plates in the orthogonal direction. Each tip portion of the at least six pivoting arms is located on an outside of each of the upper surface plates. Each acting point on which each of the at least six arm driving units acts on each of the at least six pivoting arms is located partway through each of the at least six pivoting arms. Each of the at least six arm driving units is attached to the bogie frame on a side surface of the bogie frame in the orthogonal direction or on an outside of the bogie frame.

In the present disclosure, the at least six pivoting arms may include four inner arms that support a rear portion of a front tire or a front portion of a rear tire of the four-wheeled vehicle. The at least six arm driving units may include four inner arm driving units that individually drive the inner arms. Each acting point on which each of the inner arm driving units acts on each of the inner arms may be located partway through each of the inner arms. Each of the inner arm driving units may be attached to the side surface of the bogie frame in the orthogonal direction.

In the present disclosure, each of the inner arms may be provided with a groove provided on a surface facing each of the inner arm driving units. In the tire release state, an axial direction of each of the inner arms may coincide with the longitudinal direction. In the tire release state, each of a part of the inner arm driving units may be housed in each groove.

In the present disclosure, the vehicle transporting device may further include a support shaft. The support shaft may be provided on the side surface of the bogie frame in the longitudinal direction. The support shaft may extend in the longitudinal direction on the outside of the bogie frame. The at least six pivoting arms may include two outer arms that support a front portion of the front tire or a rear portion of the rear tire of the four-wheeled vehicle. The at least six arm driving units may include two outer arm driving units that individually drive the outer arms. Each acting point on which each of the outer arm driving units acts on each of the outer arms may be located partway through each of the outer arms. Each of the outer arm driving units may be attached to a side surface of the support shaft in the orthogonal direction.

In the present disclosure, the upper surface plates may include a first upper surface plate provided corresponding to one of the front tire and the rear tire of the four-wheeled vehicle, and a second upper surface plate provided corresponding to the other of the front tire and the rear tire of the four-wheeled vehicle. Sizes of the first upper surface plate and the second upper surface plate in the orthogonal direction may be designed to be shorter than a predetermined tread width of the four-wheeled vehicle.

In the present disclosure, the vehicle transporting device may further include a device main body. The device main body tows the bogie frame. The arms may include two non-pivoting arms that have the shortest distance to the device main body among the arms and that support the front portion of the front tire or the rear portion of the rear tire of the four-wheeled vehicle.

According to the present disclosure, at least six arm driving units for individually driving at least six pivoting arms can be disposed on the side surface of the bogie frame or outside the bogie frame. That is, according to the present disclosure, the conventional bulky link mechanism becomes unnecessary. Therefore, it is possible to reduce the size of the bogie frame in the vertical direction. Further, by reducing the size of the at least six pivoting arms in the vertical direction as well as that of the bogie frame in the vertical direction, it is possible to transport a four-wheeled vehicle having a narrow space below the vehicle body. This contributes to the expansion of the range of four-wheeled vehicles that can be transported.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a vehicle transporting device according to an embodiment;

FIG. 2 is a plan view of the vehicle transporting device according to the embodiment; FIG. 3A is a diagram illustrating an operation example when the vehicle transporting device according to the embodiment transports a four-wheeled vehicle;

FIG. 3B is a diagram illustrating an operation example when the vehicle transporting device according to the embodiment transports a four-wheeled vehicle;

FIG. 4A is a diagram illustrating the operation example when the vehicle transporting device according to the embodiment transports the four-wheeled vehicle;

FIG. 4B is a diagram illustrating the operation example when the vehicle transporting device according to the embodiment transports the four-wheeled vehicle;

FIG. 5A is a diagram illustrating features of the vehicle transporting device according to the embodiment;

FIG. 5B is a diagram illustrating features of the vehicle transporting device according to the embodiment;

FIG. 6 is a diagram illustrating features of the vehicle transporting device according to the embodiment;

FIG. 7A is a diagram illustrating features of the vehicle transporting device according to the embodiment; and

FIG. 7B is a diagram illustrating features of the vehicle transporting device according to the embodiment.

### DETAILED DESCRIPTION OF EMBODIMENTS

Hereinafter, a vehicle transporting device according to an embodiment of the present disclosure will be described with reference to the drawings. In each figure, the same or corresponding parts are designated by the same reference signs to simplify or omit the description.

### 1. Configuration Example of Vehicle Transporting Device

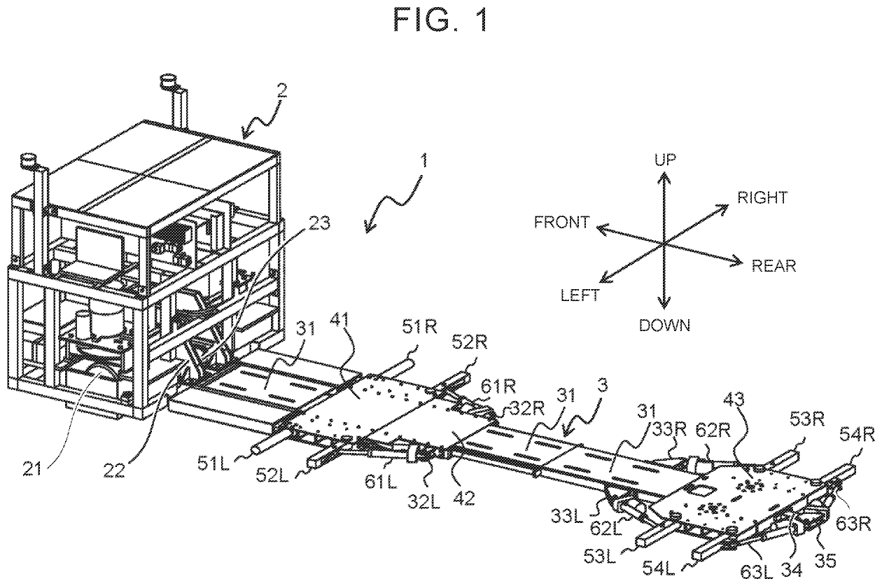

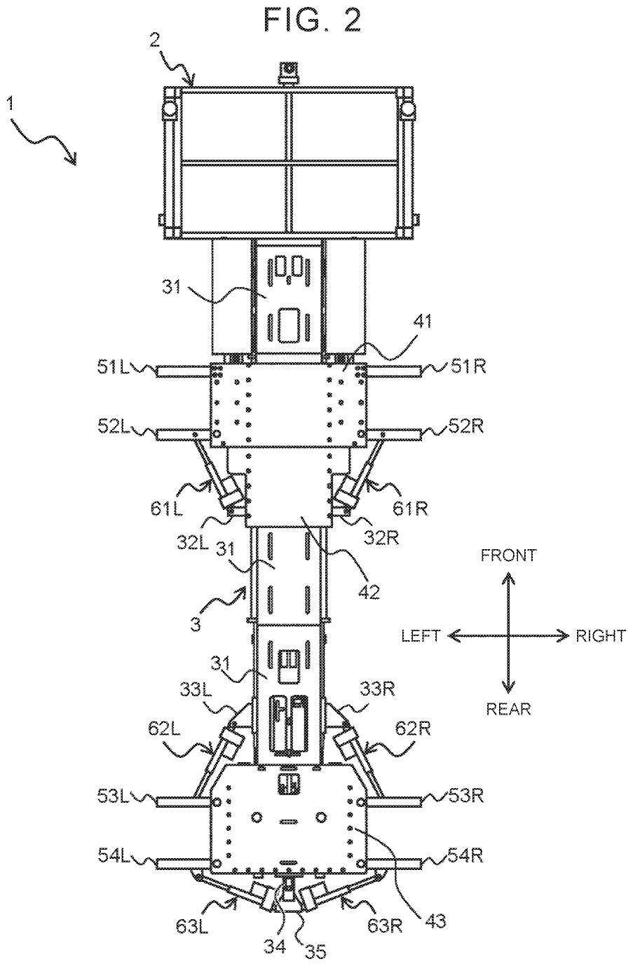

The vehicle transporting device according to the embodiment is a device for transporting a four-wheeled vehicle. A configuration example of the vehicle transporting device will be described with reference to FIGS. 1 and 2. FIG. 1 is a perspective view of the vehicle transporting device according to the embodiment, and FIG. 2 is a plan view of the vehicle transporting device according to the embodiment. As shown in FIGS. 1 and 2, a vehicle transporting device 1 includes a device main body 2, a bogie frame 3, and a total of eight arms 51L to 54L and 51R to 54R as main configurations.

The device main body 2 has a function of traveling while towing the bogie frame 3. As a configuration for this towing traveling function, the device main body 2 includes, for example, a drive device, a braking device, and a steering device. The drive device is, for example, a motor, and the motor drives bogie front wheels 21. Two bogie front wheels 21 are disposed in the width direction (right-left direction shown in FIGS. 1 and 2) of the device main body 2. The braking device applies braking force to the bogie front wheels 21. The steering device controls the turning angle of the bogie front wheels 21. The configuration for functioning as a traveling device is not particularly limited, and a known configuration is applied.

The device main body 2 also has a function of raising and lowering the bogie frame 3. As a configuration for the raising and lowering function, the device main body 2 includes, for example, an upright frame 22 and an elevating device 23. The upright frame 22 is provided at the front end of the bogie frame 3 so as to be perpendicular to the plane defined by the bogie frame 3. The device main body 2 and the bogie frame 3 are connected by the upright frame 22. The elevating device 23 is disposed in a space surrounded by the upright frame 22. The configuration of the elevating device 23 is not particularly limited. The elevating device 23 is composed of, for example, an air spring that utilizes compressed air. In another example, the elevating device 23 is configured by a hydraulic cylinder.

The bogie frame 3 has two or more square pipes as main members. In the internal space of these square pipes, electric wires for supplying electric power to various actuators provided in the bogie frame 3 and electric wires for transmitting control signals to the various actuators are provided. The bogie frame 3 also includes frame members that surround these square pipes and cover members that cover the space surrounded by the frame members. In FIGS. 1 and 2, three upper surface covers 31 are illustrated as the cover members. These upper surface covers 31 are disposed side by side in the longitudinal direction (front-rear direction shown in FIGS. 1 and 2) of the bogie frame 3. In the bogie frame 3, a plurality of lower surface covers serving as cover members are disposed at positions substantially corresponding to the positions where the upper surface covers 31 are disposed.

The bogie frame 3 is provided with upper surface plates 41, 42, and 43. The upper surface plates 41 and 42 are located between the two upper surface covers 31. The upper surface plate 43 is located rearward of the bogie frame 3. The positions of the upper surface plates 41, 42, and 43 in the height direction are substantially equal to those of the upper surface covers 31. The upper surface plates 41 and 43 extend in the width direction of the bogie frame 3. The widths of the upper surface plates 41 and 43 are wider than the width of the bogie frame 3. The width of a part of the upper surface plate 42 is wider than the width of the bogie frame 3. The widths of the upper surface plates 41 and 43 are designed to be shorter than the tread width of a predetermined four-wheeled vehicle that is supposed to be transported by the vehicle transporting device 1. The upper surface plates 41 and 43 correspond to the “first and second upper surface plates”.

At positions corresponding to outer peripheral regions of the upper surface plate 41 located outside the bogie frame 3, a lower surface plate to be combined with the outer peripheral regions is disposed. The arms 51L and 51R and the arms 52L and 52R are provided in the outer peripheral regions of the upper surface plate 41. The arm 51L and the arm 52L constitute a pair. The arm 51R and the arm 52R constitute a pair. The arms 51L and 51R are fixed to the upper surface plate 41. The arms 52L and 52R are each supported to be pivotable with respect to the upper surface plate 41. That is, the arms 51L and 51R correspond to “non-pivoting arms”, and the arms 52L and 52R correspond to “pivoting arms”. However, the arms 51L and 51R may be “pivoting arms”.

The pivot of the arm 52L is performed by operating an arm driving unit 61L. The arm driving unit 61L is connected to the bogie frame 3 via a connecting member 32L on the side surface of the bogie frame 3 in the width direction (right-left direction shown in FIGS. 1 and 2) of the bogie frame 3. The connecting member 32L is attached to the side surface of the frame member whose upper surface is covered by the upper surface plate 42. The connecting member 32L supports the end portion of the arm driving unit 61L so that the arm driving unit 61L is pivotable. The configuration of the arm 52R is the same as that of the arm 52L. That is, the configuration of an arm driving unit 61R is the same as that of the arm driving unit 61L, and the configuration of a connecting member 32R is the same as that of the connecting member 32L.

Similar to the upper surface plate 41, at positions corresponding to outer peripheral regions of the upper surface plate 43 located outside the bogie frame 3, a lower surface plate to be combined with the outer peripheral regions is disposed. The arms 53L and 53R and the arms 54L and 54R are provided in the outer peripheral regions of the upper surface plate 43. The arm 53L and the arm 54L constitute a pair. The arm 53R and the arm 54R constitute a pair. The arms 53L, 53R, 54L, and 54R are each supported to be pivotable with respect to the upper surface plate 43. That is, the arms 53L, 53R, 54L, and 54R correspond to “pivoting arms”.

The pivot of the arm 53L is performed by operating an arm driving unit 62L. The arm driving unit 62L is connected to the bogie frame 3 via a connecting member 33L on the side surface of the bogie frame 3 in the width direction (right-left direction shown in FIGS. 1 and 2) of the bogie frame 3. The connecting member 33L is attached to the side surface of the frame member. The connecting member 33L supports the end portion of the arm driving unit 62L so that the arm driving unit 62L is pivotable. The configuration of the arm 53R is the same as that of the arm 53L. That is, the configuration of an arm driving unit 62R is the same as that of the arm driving unit 62L, and the configuration of a connecting member 33R is the same as that of the connecting member 33L.

The pivot of the arm 54L is performed by operating an arm driving unit 63L. The arm driving unit 63L is connected to a support shaft 34 via a connecting member 35. The support shaft 34 extends from the rear center of the bogie frame 3 in the longitudinal direction of the bogie frame 3 (the front-rear direction shown in FIGS. 1 and 2). The connecting member 35 is provided at the end portion of the support shaft 34. The connecting member 35 supports the end portion of the arm driving unit 63L so that the arm driving unit 63L is pivotable. The configuration of the arm 54R is the same as that of the arm 54L. That is, the configuration of an arm driving unit 63R is the same as that of the arm driving unit 63L. The connecting member 35 is shared by the arm driving units 63L and 63R.

### 2. Operation Example When Transporting Vehicle

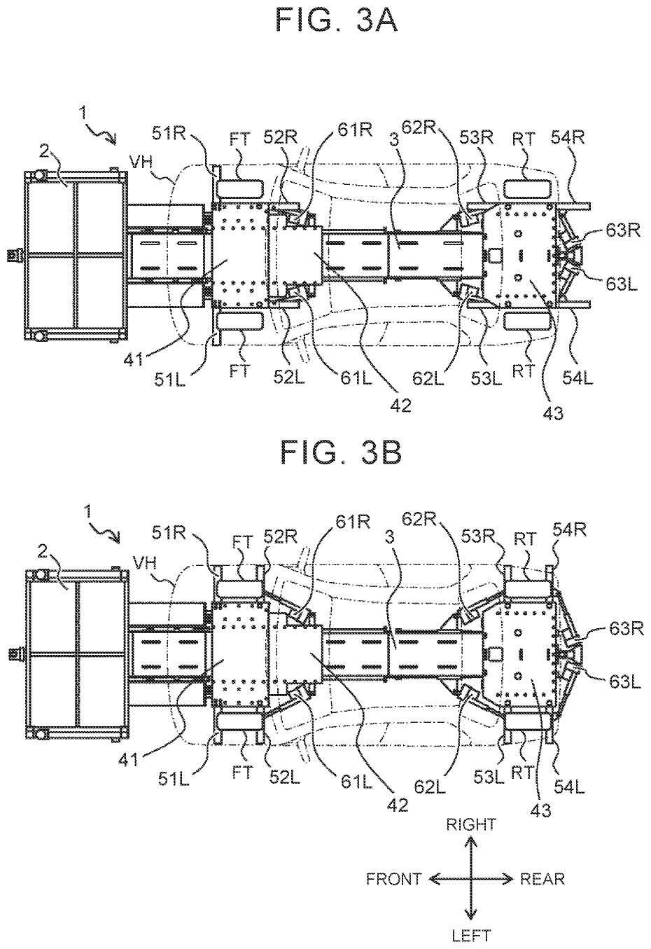

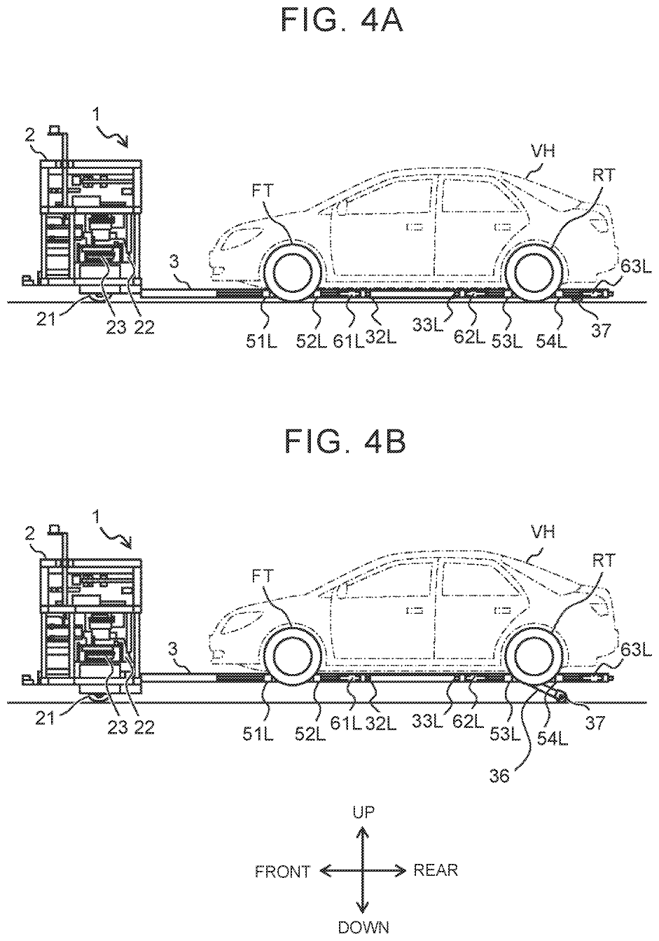

An operation example when the vehicle transporting device according to the embodiment transports a four-wheeled vehicle will be described with reference to FIGS. 3A, 3B, 4A and 4B. FIGS. 3A and 3B mainly describe the operation of the arms, and FIGS. 4A and 4B mainly describe the operation of the bogie frame. For convenience of explanation, FIGS. 3A, 3B, 4A and 4B illustrate a four-wheeled vehicle VH and its front tires FT and rear tires RT. In the examples shown in FIGS. 3A, 3B, 4A and 4B, the front tires FT are located in the front direction of the bogie frame 3, but the rear tires RT may be located at this position.

FIG. 3A is a diagram illustrating a tire release state performed by the vehicle transporting device 1. In the example shown in FIG. 3A, the bogie frame 3 is inserted into the space below the vehicle body of the four-wheeled vehicle VH. Insertion into the space below the vehicle body is performed by moving the bogie frame 3 rearward from the front of the stopped four-wheeled vehicle VH. Since the arms 51L and 51R are fixed to the upper surface plate 41, the insertion of the bogie frame 3 ends at the position where the front portion of the front tires FT abuts on the arms 51L and 51R.

During insertion into the space below the vehicle body, the six arms excluding the arms 51L and 51R are folded in the longitudinal direction (front-rear direction shown in FIG. 3A) of the bogie frame 3. Specifically, the tip portions of the arms 52L, 52R, 54L and 54R are folded so as to face the rear of the bogie frame 3. In addition, the tip portions of the arms 53L and 53R are folded so as to face the front of the bogie frame 3. By folding these six arms, the bogie frame 3 can be smoothly inserted into the space below the vehicle body.

FIG. 3B is a diagram illustrating a tire support state performed by the vehicle transporting device 1. In the example shown in FIG. 3B, the six arms excluding the arms 51L and 51R face the same direction as the extending direction (right-left direction shown in FIG. 3B) of the arms 51L and 51R. At this time, the arm 51L and the arm 52L constitute a pair and support the left front tire FT. The arm 51R and the arm 52R constitute a pair and support the right front tire FT. The arm 53L and the arm 54L constitute a pair and support the left rear tire RT. The arm 53R and the arm 54R constitute a pair and support the right rear tire RT.

FIG. 4A is a diagram showing a lowered state of the bogie frame 3 performed by the vehicle transporting device 1. FIG. 4A corresponds to the state of the vehicle transporting device 1 after the operation described in FIG. 3B is completed. The bogie frame 3 is in the lowered state while the vehicle transporting device 1 does not transport the four-wheeled vehicle VH.

As can be seen from FIG. 4A, the arm 51L supports the front portion of the left front tire FT, and the arm 52L supports the rear portion thereof. The arm 53L supports the front portion of the left rear tire RT, and the arm 54L supports the rear portion thereof. When the longitudinal direction of the bogie frame 3 (the front-rear direction shown in FIG. 4A) is used as a reference, the arms 52L and 53L are classified into “inner arms” indicating “pivoting arms” located relatively inward. On the other hand, the arm 54L is classified into an “outer arm” indicating a “pivoting arm” located relatively outward. This classification between the “inner arm” and the “outer arm” also applies to the arms 52R to 54R.

FIG. 4B is a diagram showing a raised state of the bogie frame 3 performed by the vehicle transporting device 1. FIG. 4B corresponds to a state after the state described in FIG. 4A and before the transportation of the four-wheeled vehicle VH. The raising of the bogie frame 3 is performed by a combination of the elevating device 23 and an elevating device 36 included in the bogie frame 3. The elevating device 36 is housed in the back surface of the upper surface plate 43. A known configuration such as an air spring and a hydraulic cylinder is applied to the elevating device 36. When the retracted state of the elevating device 36 is released, the bogie frame 3 is lifted while maintaining the position of a bogie rear wheel 37.

When the bogie frame 3 is raised, the four-wheeled vehicle VH is lifted. When the device main body 2 advances while maintaining this lifted state, the four-wheeled vehicle VH is transported. After the device main body 2 is stopped at a predetermined position of the transportation destination, when the elevating devices 23 and 36 are operated, the bogie frame 3 is lowered. Then, when the operation of the arms described with reference to FIG. 3A is performed, the support state of the front tires FT and the rear tires RT is released.

### 3. Features of Embodiment

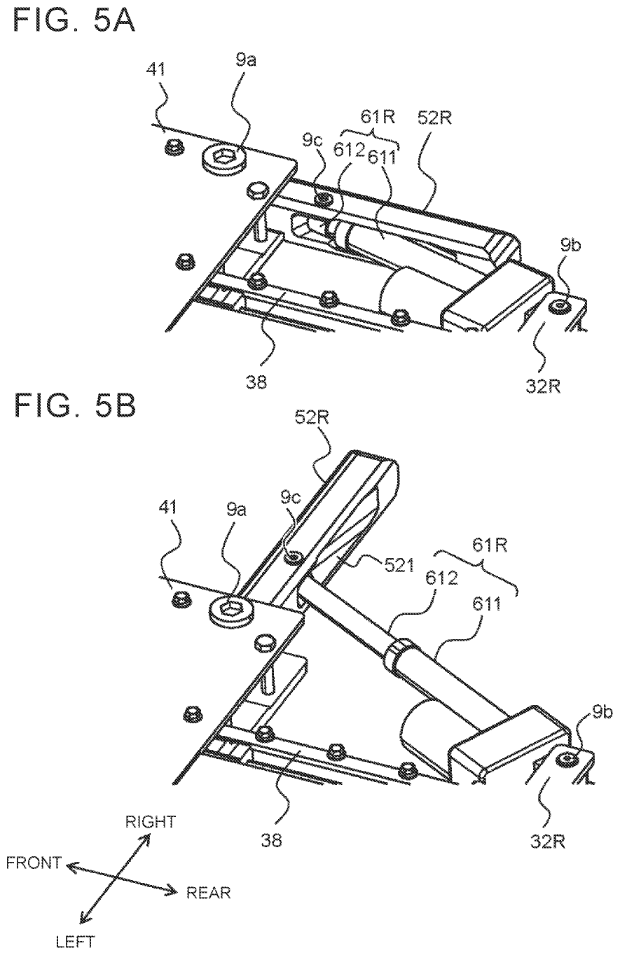

FIGS. 5A and 5B are diagrams illustrating a configuration example around the arm 52R and an operation example of the arm 52R. FIGS. 5A and 5B correspond to the two types of states described in FIGS. 3A and 3B. Although a description focusing on the arm 52R will be made here, the description of the arm 52R also applies to the description of the other “inner arms”, that is, the description of the arms 52L, 53L, and 53R.

As shown in FIGS. 5A and 5B, the arm 52R is supported to be pivotable around a pin 9a provided on the upper surface plate 41. The pin 9a is located outside the frame member 38 constituting the bogie frame 3. The arm driving unit 61R is supported to be pivotable around a pin 9b provided on the connecting member 32R. Like the position of the pin 9a , the position of the pin 9b is also outside the frame member 38. The connecting member 32R is attached to the side surface of the frame member 38, and the arm driving unit 61R drives the arm 52R on the outside of the frame member 38 and on the side (right side) of the frame member 38.

As a configuration for driving the arm 52R, the arm driving unit 61R includes a cylinder 611 and a rod 612 housed in the cylinder 611. The tip portion of the rod 612 is connected to the arm 52R via a pin 9c at a position close to the base end portion (pivoting support point) of the arm 52R. The position of the pin 9c corresponds to the acting point of the arm 52R from the arm driving unit 61R. The arm driving unit 61R drives the arm 52R by inserting and pulling out the rod 612 into and from the cylinder 611. The state in which the rod 612 is pulled into the cylinder 611 corresponds to the “tire release state”. The state in which the rod 612 is pushed out corresponds to the “tire support state”.

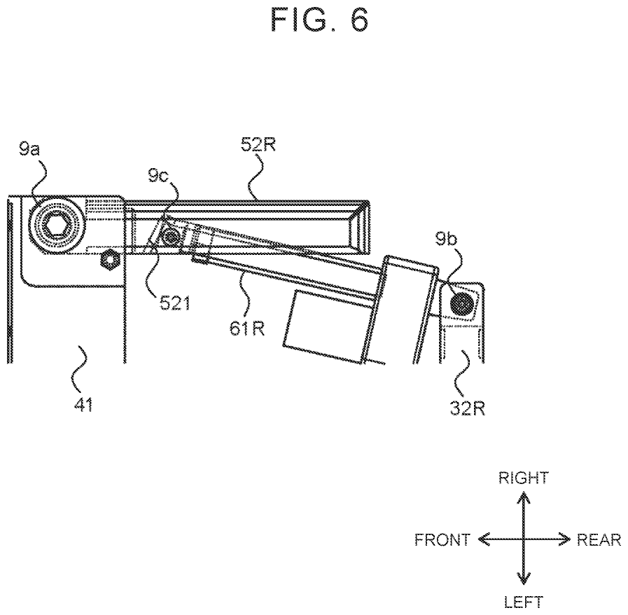

In the arm 52R, a groove 521 is provided on the surface of the arm 52R facing the arm driving unit 61R. The tip portion of the rod 612 is always housed in the groove 52. FIG. 6 is a diagram illustrating the configuration of the groove 521. FIG. 6 corresponds to a plan view of the periphery of the arm 52R in the “tire release state” described in FIG. 5A. As shown in FIG. 6, the depth of the groove 521 is the largest at the base end portion of the arm 52R, and becomes smaller toward the tip portion. In the “tire release state”, not only the tip portion of the rod 612 but also a part of the cylinder 611 are housed in the groove 521.

According to such a shape of the groove 521, the arm 52R can be folded in the “tire release state”, and the rigidity for bearing the weight of the four-wheeled vehicle VH is secured. Further, such a shape of the groove 521 contributes to the realization of an arrangement location of the arm driving unit 61R, which is on the outside of the frame member 38 and on the side of the frame member 38.

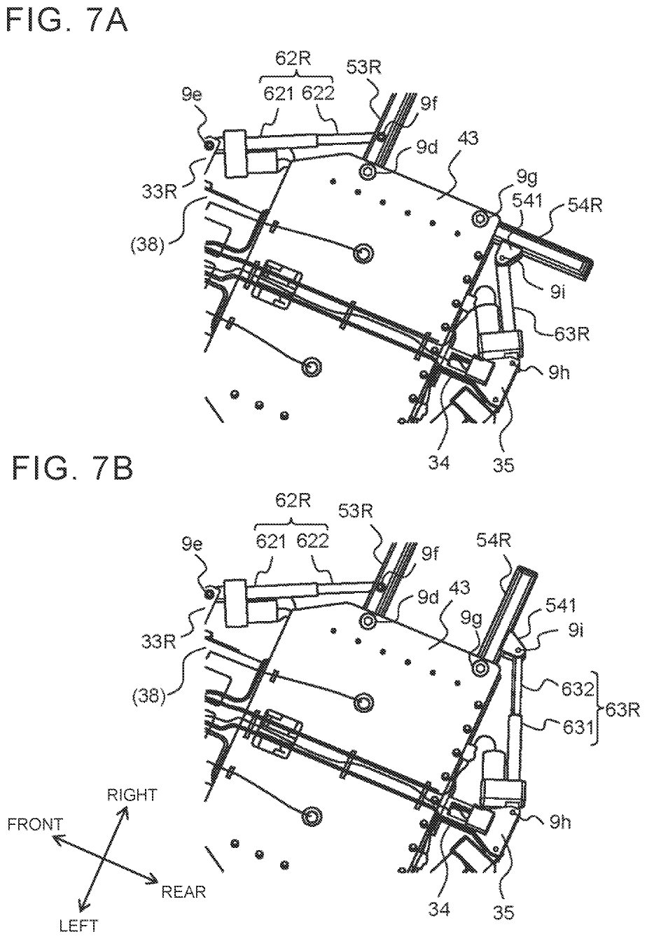

FIGS. 7A and 7B are diagrams illustrating a configuration example around the arm 54R of the upper surface plate 43 and an operation example of the arm 54R. The state of the arm 54R shown in FIG. 7A corresponds to the “tire release state”. The state of the arm 54R shown in FIG. 7B corresponds to the “tire support state”. The state of the arm 53R shown in FIGS. 7A and 7B also correspond to the “tire support state”. Although a description focusing on an operation example of the arm 54R will be made here, the description of the arm 54R also applies to the description of an operation example of the other “outer arm”, that is, the description of an operation example of the arm 54L.

As shown in FIGS. 7A and 7B, the arm 53R is supported to be pivotable around a pin 9d provided on the upper surface plate 43. The position of the pin 9d is the same as the position of the pin 9a described with reference to FIGS. 5A and 5B, and is outside the frame member 38. The arm driving unit 62R is supported to be pivotable around a pin 9e provided on the connecting member 33R. The arm driving unit 62R includes a cylinder 621 and a rod 622. The tip portion of the rod 622 is supported to be pivotable around a pin 9f at a position close to the base end portion (pivoting support point) of the arm 53R. Since the arm 53R corresponds to the same “inner arm” as the arm 52R, refer to the description of the operation example of the arm driving unit 61R described above for the description of an operation example of the arm driving unit 62R.

As shown in FIGS. 7A and 7B, the arm 54R is supported to be pivotable around a pin 9g provided on the upper surface plate 43. The position of the pin 9g is the same as the position of the pin 9a described with reference to FIGS. 5A and 5B, and is outside the frame member 38. The arm driving unit 63R is supported to be pivotable around a pin 9h provided on the connecting member 35. As described above, the connecting member 35 is provided at the end portion of the support shaft 34. Due to such an arrangement location of the connecting member 35, the arrangement location of the arm driving unit 63R, which is on the outside of the upper surface plate 43 (frame member 38) and on the side (rear side) of the upper surface plate 43 (frame member 38), is realized.

As a configuration for driving the arm 54R, the arm driving unit 63R includes a cylinder 631 and a rod 632 housed in the cylinder 631. The tip portion of the rod 632 is supported to be pivotable around a pin 9i provided on the connecting member 541. The arm driving unit 63R drives the arm 54R by inserting and pulling out the rod 632 into and from the cylinder 631. The state in which the rod 632 is pulled into the cylinder 631 corresponds to the “tire release state”. The state in which the rod 612 is pushed out corresponds to the “tire support state”.

### 4. Effect

According to the features of the embodiment described above, the arrangement location of the arm driving unit, which is on the outside of the frame member 38 and on the side of the frame member 38, is realized. That is, according to the features of the embodiment, the conventional bulky link mechanism becomes unnecessary. Therefore, it is possible to reduce the size of the bogie frame 3 in the vertical direction. Further, by reducing the size of the arm driving unit in the vertical direction as well as that of the bogie frame 3 in the vertical direction, it is possible to transport a four-wheeled vehicle VH having a narrow space below the vehicle body. This contributes to the expansion of the range of four-wheeled vehicles that can be transported.

### 5. Other Examples of Embodiment

The connection between the arm 54R and the arm driving unit 63R using the connecting member 541 described with reference to FIGS. 7A and 7B may be applied to the connection between the “inner arm” and the “inner arm driving unit” (that is, the arm driving unit that drives the “inner arm”). In addition, the connection between the arm 52R and the arm driving unit 61R using the groove 521 described with reference to FIGS. 5A and 5B may be applied to the connection between the “outer arm” and the “outer arm driving unit” (that is, the arm driving unit that drives the “outer arm”).

The arms 51L and 51R may be supported so as to be pivotable with respect to the upper surface plate 41. In this case, for the arm driving unit for driving the arms 51L and 51R, a configuration using a connecting member having the same configuration as the connecting member (connecting member 32R described with reference to FIGS. 5A and 5B) attached to the side surface of the frame member 38 is applied. The arms 51L and 51R may be connected to the arm driving unit by using the connecting member 541 described with reference to FIGS. 7A and 7B or by using the groove 521 described with reference to FIGS. 5A and 5B.

What is claimed is:

1. A vehicle transporting device that transports a four-wheeled vehicle, the vehicle transporting device comprising:
a bogie frame inserted into a space below a vehicle body from front or rear of the four-wheeled vehicle;
a total of eight arms each provided in a direction orthogonal to a longitudinal direction of the bogie frame, two arms in the longitudinal direction of the eight arms being paired with each other to support each tire of the four-wheeled vehicle;
upper surface plates extending in the orthogonal direction on an upper surface of the bogie frame to support the arms; and
at least six arm driving units provided on the bogie frame to individually switch each state of at least six pivoting arms included in the arms between a tire support state and a tire release state, wherein:
each base end portion of the at least six pivoting arms is pivotably supported by each of the upper surface plates in an outer peripheral region of each of the upper surface plates in the orthogonal direction;
each tip portion of the at least six pivoting arms is located on an outside of each of the upper surface plates;
each acting point on which each of the at least six arm driving units acts on each of the at least six pivoting arms is located partway through each of the at least six pivoting arms;
and each of the at least six arm driving units is attached to the bogie frame on a side surface of the bogie frame in the orthogonal direction or on an outside of the bogie frame.

2. The vehicle transporting device according to claim 1, wherein:
the at least six pivoting arms include four inner arms that support a rear portion of a front tire or a front portion of a rear tire of the four-wheeled vehicle; the at least six arm driving units include four inner arm driving units that individually drive the inner arms;
each acting point on which each of the inner arm driving units acts on each of the inner arms is located partway through each of the inner arms; and
each of the inner arm driving units is attached to the side surface of the bogie frame in the orthogonal direction.

3. The vehicle transporting device according to claim 2, wherein:
each of the inner arms is provided with a groove provided on a surface facing each of the inner arm driving units;
in the tire release state, an axial direction of each of the inner arms coincides with the longitudinal direction; and
in the tire release state, each of a part of the inner arm driving units is housed in each groove.

4. The vehicle transporting device according to claim 1, further comprising a support shaft provided on the side surface of the bogie frame in the longitudinal direction and extending in the longitudinal direction on the outside of the bogie frame, wherein:
the at least six pivoting arms include two outer arms that support a front portion of the front tire or a rear portion of the rear tire of the four-wheeled vehicle;
the at least six arm driving units include two outer arm driving units that individually drive the outer arms;
each acting point on which each of the outer arm driving units acts on each of the outer arms is located partway through each of the outer arms; and
each of the outer arm driving units is attached to a side surface of the support shaft in the orthogonal direction.

5. The vehicle transporting device according to claim 1, wherein: the upper surface plates include a first upper surface plate provided corresponding to one of the front tire and the rear tire of the four-wheeled vehicle, and a second upper surface plate provided corresponding to the other of the front tire and the rear tire of the four-wheeled vehicle; and
sizes of the first upper surface plate and the second upper surface plate in the orthogonal direction are designed to be shorter than a predetermined tread width of the four-wheeled vehicle.

6. The vehicle transporting device according to claim 1, further comprising a device main body that tows the bogie frame, wherein the arms include two non-pivoting arms that have the shortest distance to the device main body among the arms and that support the front portion of the front tire or the rear portion of the rear tire of the four-wheeled vehicle.
